(19) United States
(12) Patent Application Publication
(10) Pub. No.: US 2013/0012138 A1
(43) Pub. Date: Jan. 10, 2013

(54) METHOD FOR IMPROVING ROBUSTNESS OF SPECTRUM SENSING IN PRESENCE OF BURSTY INTERFERENCE

(75) Inventors: Wenyi Zhang, Hefei (CN); Cong Shen, San Diego, CA (US); Ahmed K. Sadek, San Diego, CA (US); Yong Jin Kim, San Diego, CA (US); Stephen J. Shellhammer, Ramona, CA (US)

(73) Assignee: QUALCOMM Incorporated, San Diego, CA (US)

(21) Appl. No.: 13/177,334

(22) Filed: Jul. 6, 2011

(51) Int. Cl. H04B 17/00

(52) U.S. Cl. 455/67.13

(57) ABSTRACT

A method of wireless communication in white space includes spectrum sensing in the white space during each of multiple sensing intervals. The method also includes determining whether each of the sensing intervals is subject to interference. The determining process may be based on a time domain analysis or a frequency domain analysis of signal power during each sensing interval.

### TECHNICAL FIELD

The present description is related, generally, to spectrum sensing in the white space spectrum and, more specifically, to spectrum sensing in the presence of busty interference.

### BACKGROUND

The Federal Communications Commission (FCC) is an independent agency of the United States government that is charged with regulating all non-federal government use of the radio spectrum (including radio and TV broadcasting), and all interstate telecommunications (wire, satellite and cable) as well as all international communications that originate or terminate in the United States. In 2010, the FCC finalized rules approving the unlicensed signal operation in the unused TV channels (i.e., white space). The new rules allow wireless technologies to use the TV white space as long as the technology and any resulting signal transmissions do not interfere with the existing primary users. For example, cognitive devices, such as white space devices, are allowed to use TV frequency bands if they do not cause harmful interference to TV receivers. Thus, cognitive radio demands a technology that can continuously sense the environment, dynamically identify unused spectral segments, and then operate in these white spaces without causing harmful interference to the incumbent users. Cognitive radio is a paradigm for wireless communication in which either a network or a wireless node changes its transmission or reception parameters to communicate efficiently avoiding interference with licensed or unlicensed users.

There are three types of primary signals: digital TV, which follows the ATSC format in North America; analog TV, which follows the NTSC format; and wireless microphones, which are narrowband (less than 200 kHz) signals with tunable operating frequency and typically use analog frequency modulation (FM). Other applicable signals include any applications that are entitled by regulations to use a specified portion of the spectrum. For purposes of this disclosure, the various devices that utilize such technologies to access this TV white space will be referred to as “white space devices,” “unlicensed devices,” “white space sensing devices,” or the like.

White space devices with spectrum sensing capability generally operate in a cognitive manner in which the devices first scan to detect TV band signals from licensed primary users. The white space devices will then select unused channels in order to avoid interference with the licensed signals. Therefore, these white space devices generally share two common functions: (1) sensing for incumbent signals; and (2) selecting appropriate channels for interference avoidance. These two functions have different sets of requirements. For example, in performing signal sensing, the FCC dictates that the white space devices should be capable of detecting non-bursty licensed signals at levels as low as −114 dBm. TV band signals can actually be very strong—at levels as high as −30 dBm. In contrast, for the channel selection functionality, the white space device will select channels having minimum interference levels in the presence of bursty interference. Additionally, these white space devices will not consider selecting channels having a received signal strength indication (RSSI) level that exceeds some designated noise threshold. Therefore, it is important to design effective methods to ensure that the spectrum sensing techniques work under the existence of interference.

### SUMMARY

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

According to some aspect of the disclosure, a method of wireless communication in white space includes spectrum sensing in the white space during each of multiple of sensing intervals and determining whether each of the sensing intervals is subject to interference based on a time domain analysis or frequency domain analysis of signal power during each sensing interval. The method may also include determining whether each of the sensing intervals is subject to interference based on a frequency domain analysis of signal power during each sensing interval.

According to some aspects of the disclosure, a method of wireless communication in white space includes spectrum sensing in the white space during each of multiple of sensing intervals. The method also includes processing a sensing interval by transforming or discarding the sensing interval based on an overload bit of an analog to digital converter. The transforming includes setting the power of an affected portion of an interfered signal to a predetermined value or a value interpolated from adjacent samples of the signal when the overload bit indicates occurrence of an overload condition. The discarding occurs when a number of overload bits of the analog to digital converter exceeds a predetermined threshold.

In some aspects of the disclosure, an apparatus for wireless communication in white space includes a means for spectrum sensing in the white space during each of multiple of sensing intervals and a means for determining whether each of the sensing intervals is subject to interference based on a time domain analysis of signal power during each sensing interval. The method may also include a means for determining whether each of the sensing intervals is subject to interference based on a frequency domain analysis of signal power during each sensing interval.

In some aspects of the disclosure, an apparatus for wireless communication in white space includes a means for spectrum sensing in the white space during each of multiple of sensing intervals. The apparatus also includes a means for processing a sensing interval by means for transforming or a means for discarding the sensing interval based on an overload bit of an analog to digital converter. The means for transforming includes a means for setting the power of an affected portion of an interfered signal to a predetermined value or a value interpolated from adjacent samples of the signal when the overload bit indicates occurrence of an overload condition. The means for discarding is implemented when a number of overload bits of the analog to digital converter exceeds a predetermined threshold.

According to some aspects of the disclosure, a computer program product for wireless communication in white space includes a computer-readable medium having a program code recorded thereon. The program code includes program code to spectrum sense in the white space during each of multiple of sensing intervals. The program code also includes program code to determine whether each of the sensing intervals is subject to interference based on a time domain analysis of signal power during each sensing interval.

According to some aspects of the disclosure, a computer program product for wireless communication in white space includes a computer-readable medium having a program code recorded thereon. The program code includes program code to spectrum sense in the white space during each of multiple of sensing intervals. The program code also includes program code to process a sensing interval by transforming or discarding the sensing interval based on an overload bit of an analog to digital converter. The transforming includes setting the power of an affected portion of an interfered signal to a predetermined value or a value interpolated from adjacent samples of the signal when the overload bit indicates occurrence of an overload condition. The discarding occurs when a number of overload bits of the analog to digital converter exceeds a predetermined threshold.

In some aspects of the disclosure, an apparatus for wireless communication in white space includes a memory and at least one processor coupled to the memory. The at least one processor is configured to spectrum sense in the white space during each of multiple of sensing intervals and to determine whether each of the sensing intervals is subject to interference based on a time domain analysis of signal power during each sensing interval.

In some aspects of the disclosure, an apparatus for wireless communication in white space includes a memory and at least one processor coupled to the memory. The at least one processor is configured to spectrum sense in the white space during each of multiple of sensing intervals. The at least one processor is also configured to process a sensing interval by transforming or discarding the sensing interval based on an overload bit of an analog to digital converter. The transforming includes setting the power of an affected portion of an interfered signal to a predetermined value or a value interpolated from adjacent samples of the signal when the overload bit indicates occurrence of an overload condition. The discarding occurs when a number of overload bits of the analog to digital converter exceeds a predetermined threshold.

### BRIEF DESCRIPTION OF THE DRAWINGS

For a more complete understanding of the present teachings, reference is now made to the following description taken in conjunction with the accompanying drawings.

FIG. 1 is a block diagram illustrating an exemplary white space network in which an embodiment of the disclosure may be advantageously employed.

FIG. 2 illustrates an example of a white space sensing device according to an embodiment of the disclosure.

FIG. 3A illustrates a waveform of a received signal, without bursty interference, as a function of time.

FIG. 3B illustrates the corresponding spectrum of the waveform of FIG. 3A.

FIG. 4A illustrates a waveform of a received signal, with bursty interference, as a function of time.

FIG. 4B illustrates the corresponding spectrum of the waveform of FIG. 4A.

FIG. 5A illustrates power spectral density (PSD) in dB versus baseband frequency in megahertz (MHz) of an ATSC signal without bursty interference.

FIG. 5B illustrates power spectral density (PSD) in dB versus baseband frequency in megahertz (MHz) of an ATSC signal with bursty interference.

FIG. 6 illustrates a cumulative distribution function (CDF) of an ATSC sensing metric with and without bursty interference.

FIG. 7 illustrates a schematic block diagram of a first method of identifying a spectrum sensing interval that is poisoned or affected by bursty interference.

FIG. 8 illustrates a schematic block diagram of a first implementation procedure of a signal power measurement block of FIG. 7.

FIG. 9 illustrates a schematic block diagram of a second implementation procedure of the signal power measurement block of FIG. 7.

FIG. 10 illustrates a schematic block diagram of a second method of identifying a spectrum sensing interval that is poisoned or affected by bursty interference.

FIG. 11 illustrates a schematic block diagram of a third method for repairing a spectrum sensing interval, poisoned or affected by bursty interference.

FIG. 12 illustrates an Analog-to-Digital Converter (ADC) configured to detect bursty interference.

FIG. 13 illustrates a method of wireless communication in white space according to an embodiment of the disclosure.

FIG. 14 illustrates an exemplary method of wireless communication in white space according to an embodiment of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

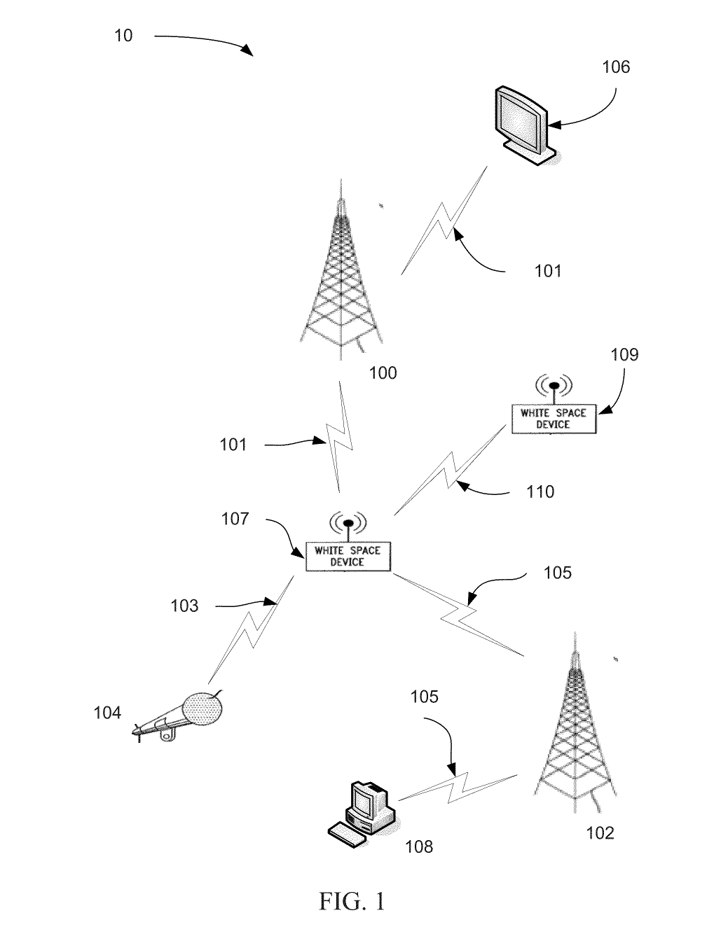

Referring to FIG. 1, a block diagram is shown conceptually illustrating a, white space network 10 configured according to one embodiment of the present teachings. The white space network 10 may be a television white space network that includes certain television channel frequencies for use by certain wireless microphone systems. The white space network may include licensed ATSC signals 101 and licensed NTSC signals 105 that originate from primary users, such as TV broadcasters and the like. The TV white space network may also include a wireless microphone signal 103 generated by a wireless microphone 104, for example. The ATSC signal 101 and the NTSC signal 105 may be generated from an ATSC transmitter 100 and a NTSC transmitter 102, respectively. Many different devices 106 and 108, such as a TV tuner, a computer and the like, may use such licensed ATSC and NTSC signals 101 and 105. Each of the ATSC signals 101, the NTSC signals 105 and the wireless microphone signals 103 are licensed signals protected from interference by FCC regulations of various white space devices 107 or 109. In order to operate such white space devices 107 along side of licensed ATSC signals 101, NTSC signals 105 and wireless microphone signals 103, embodiments of the present disclosure provide for white space device transmitters to monitor the white space signals, such that white space device receivers may distinguish between primary signals such as licensed ATSC signals 101, NTSC signals 105, wireless microphone signals 103, and secondary white space signals.

In some embodiments, the white space device 107 or 109 may be a device, such as devices 106 and 108, configured for white space sensing. For example, a white space device can be a laptop computer equipped with an ATSC or NTSC signal detector and internal wireless antenna, which configure the laptop computer for wirelessly transmitting and receiving white space signals. The user of a white space device 107, such as a laptop computer may have developed content that he or she intends to share over the TV white space network 10 with other white space devices, ATSC or NTSC devices, such as device 109. The white space device 107 begins by sensing the available ATSC spectrum or NTSC spectrum in its vicinity, for example. It detects the ATSC or NTSC signal 101 or 105 and identifies this channel as off-limits for any unlicensed transmissions. The white space device 107 then generates a secondary white space signal 110 that can be distinguished from the signals 101, 103 and/or 105.

The white space device 107 transmits the white space signal 110 to other white space devices, ATSC or NTSC devices, such as device 109, using a white space channel that is currently unused by any licensed transmissions. On the receiving end, the white space device 109, receives the white space signals 110, and analyzes those signals to determine whether the signals are licensed ATSC or NTSC signals or unlicensed secondary white space signals. The white space device 109 can detect that the white space signals 110 are not licensed signals 101, 103 and/or 105 and process those signals accordingly.

It should be noted that any variety of information may be communicated between white space devices 107 and 109 individually or participating in a white space network 10. Examples of such information include sensing information, such as channel availability, location information, signal strength information, white space pilot frequency information, offset information, and the like. Moreover, cooperative sensing may be enabled through sharing of resources between different white space devices 107 and 109 within the white space network 10. For example, with reference to FIG. 1, the white space device 109 may not have the capability to determine location. By leveraging the white space network 10, the white space device 109 may query the other white space devices 107 for such location information. In response, the white space device 107 may transmit such location information to the white space device 109. As such, the white space device 109 may benefit from information obtained from devices having additional capabilities.

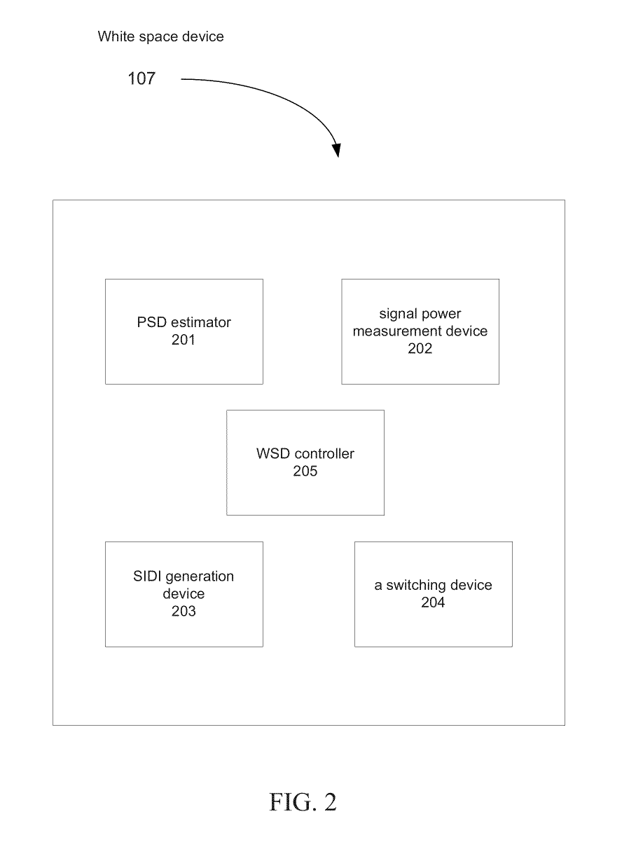

FIG. 2 illustrates an example of a white space sensing device according to an embodiment of the disclosure. For explanatory purposes, FIG. 2 will be discussed with reference to the above-discussed FIG. 1. As illustrated, the white space device 107 may have a power spectral density (PSD) estimator 201, a signal power measurement device 202, a sensing interval discarding indicator (SIDI) generation device 203, a switching device 204 and white space device (WSD) controller 205. In some embodiments, at least some of the devices 201-205 are incorporated into a single device. In some embodiments, at least some of the devices 201-205 are independent but coupled to the other devices. The power spectral estimator or power spectral density estimator 201 can be configured to estimate the spectral density (also known as the power spectrum) of the received signal, 103, 101 or 105, for example, from a sequence of time samples.

In some embodiments, the signal power measurement device 202 is configured to keep track of the power level at the input of the power spectral estimator 201. The signal power measurement device 202 computes a received signal strength indicator (RSSI). In the event that an abrupt rise in the RSSI occurs and holds for a while, the signal power measurement device 202 generates a sensing interval discarding indicator (SIDI) to notify the power spectral estimator 201 to stop and discard the entire sensing interval of the received signal. In some embodiments, the SIDI is generated by a SIDI generation device 203, which may be an integral part of, or independent of the signal power measurement device 202. In some embodiments, a switching device 204, for example, an estimated power switch, coupled to the SIDI generation device 203, can be configured to be activated in response to receiving an SIDI. For example, in the event of a bursty signal, an SIDI is generated that causes the estimated power switch 204 to open thereby preventing spectral density processing of the spectrum sensing interval associated with the SIDI. The WSD controller 205 or decision making device is configured to receive the estimated spectral density of the received signal for processing. For example, the WSD controller 205 may identify a channel as off-limits for any unlicensed transmission based on the processing of the spectral density of the received signal.

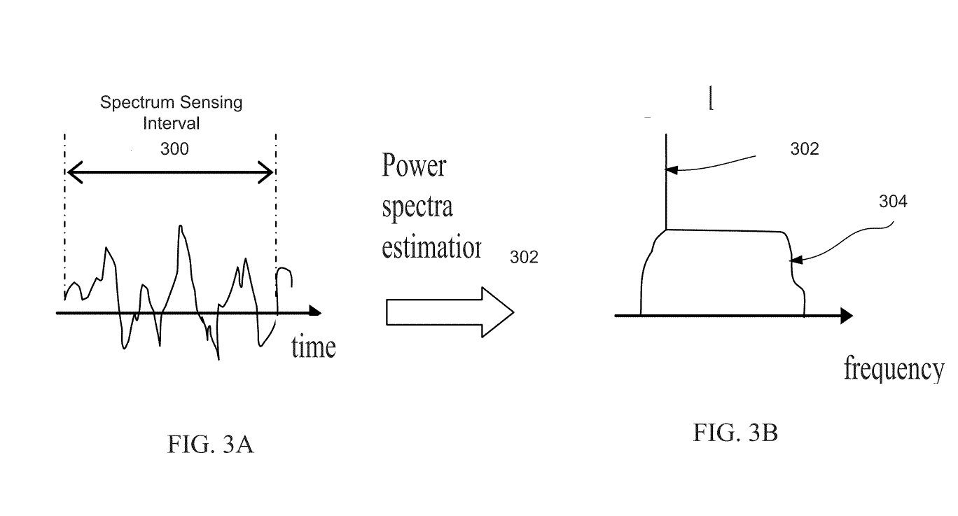

FIG. 3A illustrates a waveform of a received signal, without burst, as a function of time and FIG. 3B illustrates the corresponding frequency spectrum of the waveform of FIG. 3A to be detected with the spectrum sensing device or white space device 107 or 109. The spectrum sensing device may be incorporated in the white space device 107 or 109 illustrated in FIG. 1. The waveform of the received signal may be received and implemented in the white space devices 107 or 109 illustrated in FIG. 1. The signal may be received at a receiver (not shown) of the white space device 107 or 109. The receiver may be a conventional receiving device, which takes as input a RF signal (received signal), down-converts it to baseband, filters out images, and samples the baseband signal to discrete-time form. In FIG. 3A, the received signal is illustrated in the time domain where the vertical axis is the amplitude (power) and the horizontal axis is the time (t)). The received signal may be subdivided into spectrum sensing intervals 300 for further analysis of the spectral features of the received signal. For example, FIG. 3B illustrates a spectral feature of the time domain received signal of FIG. 3A.

For spectrum sensing techniques based on power spectra, the spectral features of primary signals distinguish them from the background noise 304 (possibly plus noise-like traffic or interference) floor as spikes 302 illustrated in FIG. 3B, for example. In order to ensure that the spectrum sensing techniques operates properly, it is desirable for the received signal to contain only noise and possibly primary signals, without any other interference. In other words, when the spectrum sensor is operating, it prefers that all its neighboring TV white space devices are kept “quiet”. As TV white space applications (for example, Wi-Fi) emerge in the future, unfortunately such a quiet condition may be difficult to guarantee, due to the fact that the TV white space devices generally belong to heterogeneous networks without being able to inter-operate each other. Therefore, even if all the devices in the network are quieted at a common time, there may be devices in a neighboring network, which are not quiet during that time.

Such interference from neighboring TV white space devices may be bursty in time. For example, wireless local area network (WLAN), such as Wi-Fi is a packet-based transmission system, and in its inactive mode, a Wi-Fi transmitter only transmits short beacon bursts with a low duty cycle. Hence, a typical scenario is that for most of the spectrum sensing intervals there is no interference, but occasionally a sensing interval is “poisoned” or affected by a short burst of interference, which can be strong compared with the primary signal power level. In some applications, bursty interference may be used as a jamming mechanism, in order to render a TV white space device unable to accomplish reliable spectrum sensing, thus reducing its capability of operating in potential TV white space spectrum. Because it only requires transmitting a short burst when the spectrum sensing is run, such a jamming mechanism is both power-efficient and difficult to catch.

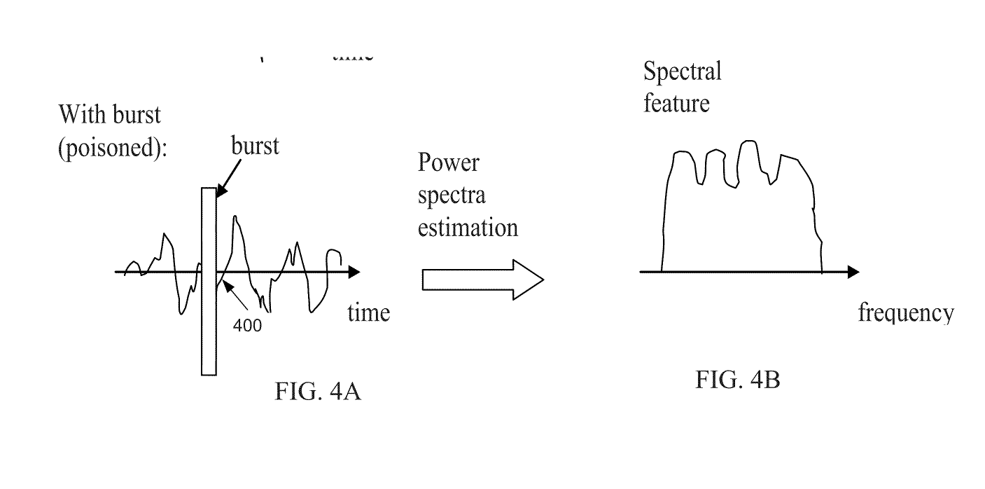

FIG. 4A illustrates a waveform of a received signal subjected to bursty interference 400, with burst, as a function of time within a spectrum sensing interval and FIG. 4B illustrates the corresponding frequency spectrum of the waveform of FIG. 4A. For those spectrum sensing intervals that are “poisoned” or interfered with a burst, the sought-for spectral features in the resulting power spectra are destroyed as illustrated in FIG. 4B. Note that, such a poisoning effect occurs in the frequency-domain (FIG. 4B) rather than the time-domain (FIG. 4A). Therefore, it can be the case that although a burst only slightly increases the total received signal power in a spectrum sensing interval, it still destroys the spectral feature. Thus, in contrast to FIG. 3B, where the spectral feature is clearly identified, the spectral feature of FIG. 4B is masked in the presence of the burst.

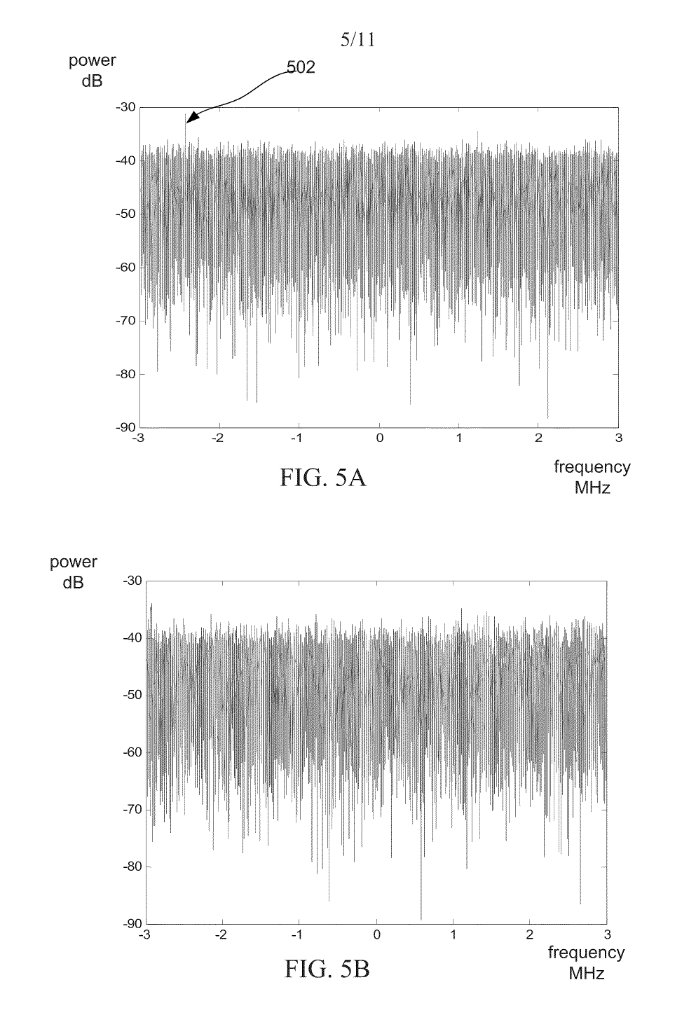

FIGS. 5A and 5B illustrate power spectral density (PSD) in dB versus baseband frequency in MHz of an ATSC signal with and without bursty interference, respectively. In some embodiments, the received signal has duration of 5 ms, and bandwidth of 6 MHz illustrated by the horizontal axes of FIGS. 5A and 5B. The received signal may include an ATSC signal of −20 dB SNR. A burst of 0.5 ms duration may be inserted and superimposed over the primary signal during 2.7-3.2 ms. For the burst, the interference power level is 30 dB above the ATSC signal. Comparing FIGS. 5A and 5B it is clear that the ATSC spectral feature 502 (the ATSC pilot located at 309 kHz above the channel lower edge −3 MHz) in FIG. 5A is masked in the presence of the burst as illustrated in FIG. 5B.

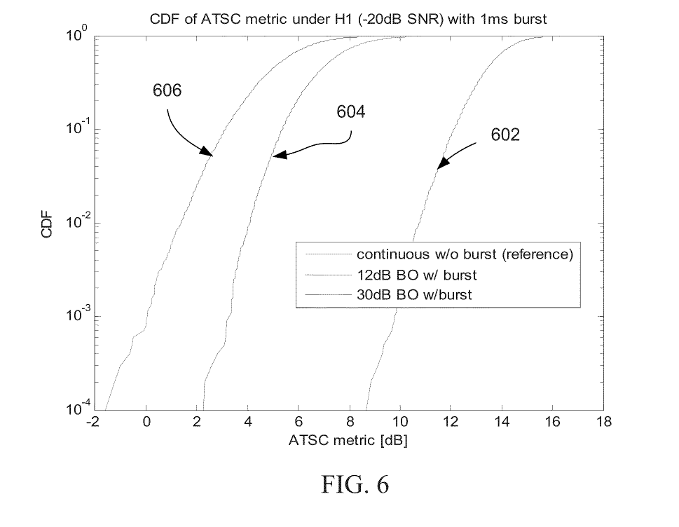

FIG. 6 illustrates a cumulative distribution function (CDF) of an ATSC sensing metric with and without bursty interference. FIG. 6 is discussed with reference to FIGS. 5A and 5B. The 5 ms received signal that contains the ATSC signal of SNR −20 dB, may be passed through an automatic gain control (AGC) of back-off (BO) 12 dB or 30 dB and a 10-bit analog-to-digital converter (ADC). In the absence of a burst, the ATSC metric averages around 10 dB as illustrated by waveform 602. It is shown that in the presence of a burst of duration 1 ms, the ATSC metrics are substantially reduced, and hence become difficult to detect as illustrated by waveforms 604 and 606. Similar observations can also be made for even shorter bursts, say, 0.1 ms.

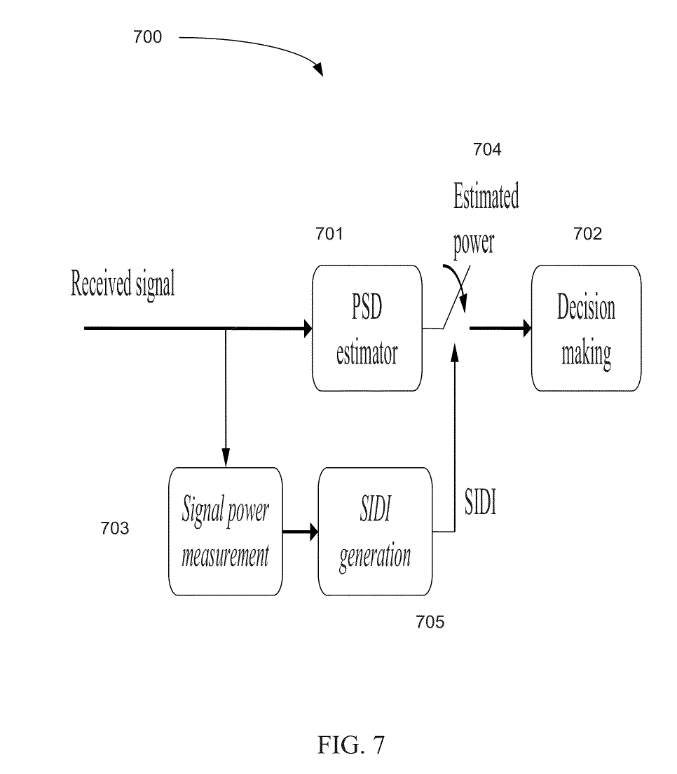

FIG. 7 illustrates a schematic block diagram 700 of a first system or solution for identifying a spectrum sensing interval poisoned or affected by bursty interference. For explanatory purposes, FIG. 7 will be discussed with reference to FIGS. 1 and 2. This system allows for identification of a spectrum sensing interval that is poisoned or affected by bursty interference by preprocessing the time-domain received signal, and then discarding the poisoned or affected interval.

As previously illustrated in FIG. 2, a PSD estimator 201, for example, associated with the PSD estimator block 701 estimates the spectral density of the received signal and then transmits it to the decision making device or WSD controller 205 associated with the decision making block 702 for further processing when there is no detection of bursty interference. In order to detect bursty interference, the signal power measurement device 202 associated with the signal power measurement block 703 tracks the power level at the input of the PSD estimator block 701. For example, the signal power measurement block 703 computes the received signal strength indicator (RSSI). In the event that an abrupt rise in the RSSI occurs and holds for a while, the signal power measurement block 703 generates a sensing interval discarding indicator (SIDI) to notify the PSD estimator 701 to stop and discard the entire sensing interval. In some embodiments, an SIDI generation device 203 associated with the SIDI block 705 can also receive notification from the signal power measurement device 202 to generate the SIDI.

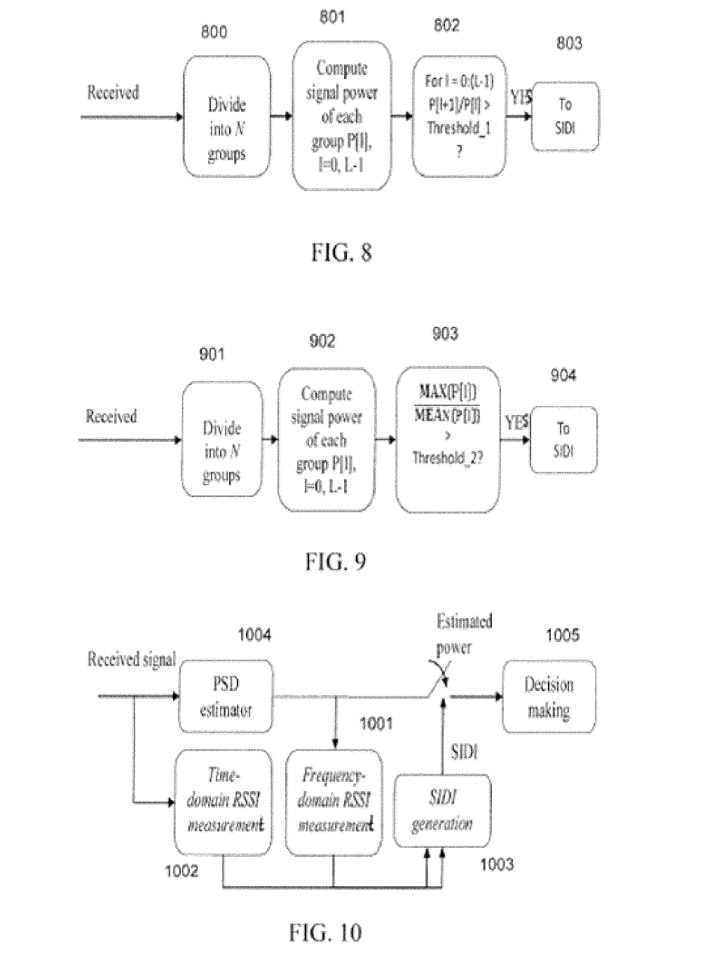

Discarding the signal sensing interval can be accomplished in conjunction with disabling the estimated power switch 704 that couples the PSD estimator 701 to the decision making device 702. As a result, a spectrum sensing interval is lost and, therefore, a prior and/or subsequent spectrum sensing interval is used to decide whether the spectrum is occupied. In some embodiments, the time-domain preprocessing method of identifying that a spectrum sensing interval is poisoned by bursty interference can be implemented by various analyses. For example, the signal power measurement block 703 can be implemented in accordance with the system of FIG. 8. A detailed example of the signal power measurement block 703 is illustrated in the schematic block diagram of FIG. 8. In block 800, the received signal is divided into N groups. In block 801, the signal power P(I) of each group is computed. In block 802, a ratio of a current signal power calculation to a previous signal power calculation is calculated and compared to a threshold value, Threshold_{—}1. If that ratio is greater than the threshold value, an SIDI is generated in block 803 to discard the current spectrum sensing interval.

In some embodiments, the time-domain preprocessing method of identifying that a spectrum sensing interval is poisoned by bursty interference can be implemented by an alternate analysis. A detailed example of the signal power measurement block 703 of this analysis is illustrated in the schematic block diagram of FIG. 9. In block 901, the received signal is divided into N groups. In block 902, the signal power P(I) of each group is computed. In block 903, a ratio of a maximum power of a spectrum sensing interval to a mean power of the spectrum sensing intervals is calculated and compared to the threshold value, Threshold_{—}2. If that ratio is greater than the threshold value, an SIDI at block 904 is generated to discard the PSD of the spectrum sensing interval. In some implementations, the mean operation of this analysis may be replaced by the median operation.

In some embodiments, a third time-domain preprocessing method of identifying whether a spectrum sensing interval is poisoned by bursty interference can be implemented by a third type of analysis in which a counter tracks high power signal groups. If there are too many of such groups (i.e., when the counter exceeds a predetermined threshold), a SIDI is generated.

Some of the benefits of the system in FIG. 7 include simplicity. However, the system allows for the loss of some information by discarding an entire sensing interval, and the possibility of falsely triggering the discarding procedure when the rise in RSSI is not due to bursts but due to primary signal fluctuation.

FIG. 10 illustrates a schematic block diagram of a second system or solution for identifying a spectrum sensing interval poisoned or affected by bursty interference. For explanatory purposes, FIG. 10 will be discussed with reference to FIGS. 1 and 2. In particular, the schematic block diagram illustrates a frequency-domain post-processing system of identifying whether a spectrum sensing interval is poisoned by bursty interference. This second system and corresponding schematic block diagram may be implemented in the white space device 107 or 109 within the white space network 10 illustrated in FIG. 1 above. The schematic block diagram of this second system is similar to that of the schematic block diagram of the first system (see, FIG. 7), except that in this case, the system includes a frequency domain RSSI measurement block 1001. The frequency domain RSSI measurement block 1001 may be coupled between the time domain RSSI measurement block 1002 and the SIDI generation block 1003.

In some embodiments, the power of the received signal can be computed in two ways based on Parseval's theorem in signal processing: (1) averaging of time-domain samples as is calculated in schematic block 1002, and (2) summing of estimated power spectra over the frequency-domain as is calculated in schematic block 1001. Based on a short (training) segment of the received signal at the beginning of a sensing interval, a first estimate of the RSSI of the received signal can be computed by time-domain averaging. The time domain RSSI measurement device 1001 can compute this time domain calculation of the RSSI. Because the signal propagation characteristics are typically slowly time varying in applications of interest, when no bursty interference exists during the sensing interval, such a RSSI measurement is not expected to change dramatically.

From summing the estimated power spectra, a second RSSI measurement can be computed. This second RSSI measurement averages over the entire sensing interval, including noise, primary signal (if exists), and bursty interference (if exists). The frequency domain RSSI may be computed in the frequency domain RSSI measurement block 1001. The computation of RSSIs according to this method is as follows:

Time-domain averaging of a short segment:

RSSI_{—}1=Power_primary+Power_noise;

Power spectra summing:

RSSI_{—}2=Power_primary+Power_noise+Power_burst.

In the above discussion, it is assumed that the training segment does not contain bursty interference. Because bursts arrive at a low duty cycle, if a burst arrives during the training segment, it is safe to assume that no new burst will arrive within the sensing interval, and hence the method is still valid even if the training segment is poisoned by bursty interference. The duration of the training segment is chosen to be no shorter than the possible burst (e.g., Wi-Fi beacon) duration.

The absolute value of the difference between the first and second RSSI values is compared against a threshold value to determine whether a sensing interval is poisoned by a bursty interference as follows:

|RSSI_{—}1−RSSI_{—}2|≧TH

where the threshold TH is a small number to allow for some small differences between RSSI_{—}1 and RSSI_{—}2, even when no interference is present

Based on this observation, a sensing interval is determined to be poisoned by bursty interference if the difference between RSSI_{—}1 and RSSI_{—}2 is larger than TH. Whenever the sensing interval was determined to have been poisoned, an SIDI is generated in the SIDI generation block 1003 to discard the entire spectrum sensing interval.

The second system has a higher complexity than the first system because it computes two RSSI measurements one of which is summing over the estimated power spectra. Nevertheless, the second solution or system is expected to have higher reliability because a sensing interval is less likely to be falsely discarded than in the first solution or system. However, the second system may also lose useful information by discarding an entire sensing interval.

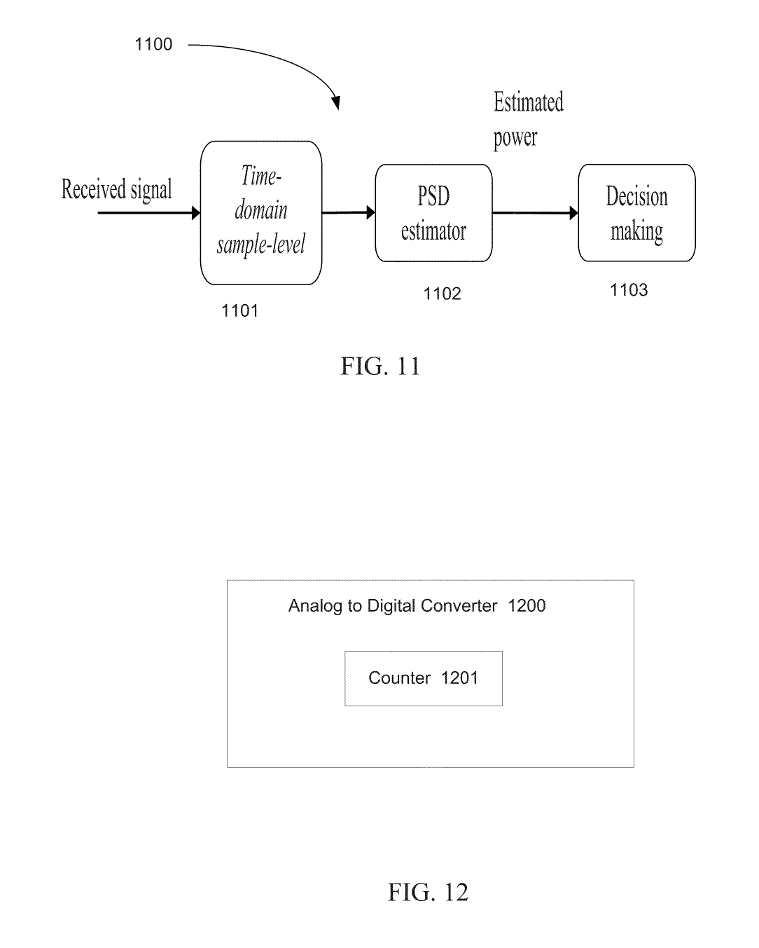

FIG. 11 illustrates a schematic block diagram of a third solution or system for repairing a spectrum sensing interval, poisoned or affected by bursty interference. In particular, the schematic block diagram 1100 illustrates a time-domain sample-level preprocessing system for repairing or “depoisoning” a spectrum sensing interval affected or poisoned by bursty interference. In some embodiments, the schematic block diagram 1100 can be implemented in a white space sensing device 107, illustrated in FIG. 1.

As discussed in the previous two solutions, an entire sensing interval when poisoned is discarded even though a burst may only affect a small fraction of an entire sensing interval. In this third solution, time-domain sample-level preprocessing “depoisons” or repairs samples affected by a burst, instead of discarding them. In some embodiments, a preprocessor, for example a time-domain sample-level preprocessor associated with block 1101, analyzes input to a power spectra estimator, for example, the PSD estimator associated with block 1102, sample by sample. Whenever the preprocessor 1101 decides a sample is poisoned by an interference burst, it transforms the value of this sample according to some predefined mapping. The decision making block 1103 is similar to the decision making blocks 702, 1005 discussed above.

In some embodiments, the mapping replaces each sample with a squared magnitude exceeding a threshold by zero. To choose the threshold, a short training phase can be employed at the beginning of the sensing interval to estimate the average power level, and then the threshold is set as the product of the estimated average power level and a constant that is greater than one. In some embodiments, other mapping schemes, such as linear smoothing or median filtering may also be used. Accordingly, in the system 1101 of FIG. 11 no SIDI is generated, and every sensing interval is utilized. In some embodiments, instead of replacing the sample with 0 when the signal power exceeds the threshold, the sample filtering techniques are used to interpolate over valid adjacent samples to regenerate.

The third system is advantageous relative to the first and second solutions, in that it does not discard any sensing interval. However, because the preprocessing itself may not perfectly remove the effect of bursty interference, the resulting power spectra estimation may have somewhat degraded quality. Thus, the third method is particularly effective when the degradation of the resulting power spectra estimation is moderate.

FIG. 12 illustrates an Analog-to-Digital Converter (ADC) 1200 configured to detect bursty interference. The ADC 1200 includes a counter 1201 that can be incorporated into the ADC 1200 or that can be independent but coupled to the ADC 1200. The ADC 1200 is configured to receive a signal 103 or 105, illustrated with respect to FIG. 1. In some embodiments, unused bit(s) of an Analog-to-Digital Converter (ADC) 1200 are used to detect if bursty interference is present in the received signal. For example, 12 bits out of a 16-bit ADC 1200 may be used leaving 4 unused bits. In one example, an ADC overload bit is used to detect if bursty interference is present in a current sensing interval. The overload bit is set when the ADC 1200 receives a signal with a power level above some threshold. A counter 1201 is accumulated or increased every time the ADC 1200 overload bit indicates that bursty interference is present in the sensing interval, during each quiet time. If the counter 1201 exceeds some predetermined threshold value, an SIDI is generated to discard the entire sensing interval of the received signal.

In another example, similar to the third solution, whenever the ADC 1200 overload bit indicates the presence of a bursty interference, the power of an affected portion of an interfered signal is set to a predetermined value to reduce/minimize its contribution to the total power of the remaining residual signals associated with the sensing interval of the received interfered signal. In some embodiments, the power of multiple interfered portions of the interfered signal are reduced/minimized. The power of an interfered portion of the received signals can be reduced/minimized to zero. In some embodiments, instead of reducing/minimizing the power of the affected portions of the interfered signal to zero or a reduced/minimum value, the sensing interval is transformed by setting the power of the affected portion of the interfered signal to a value interpolated from adjacent samples of the signal.

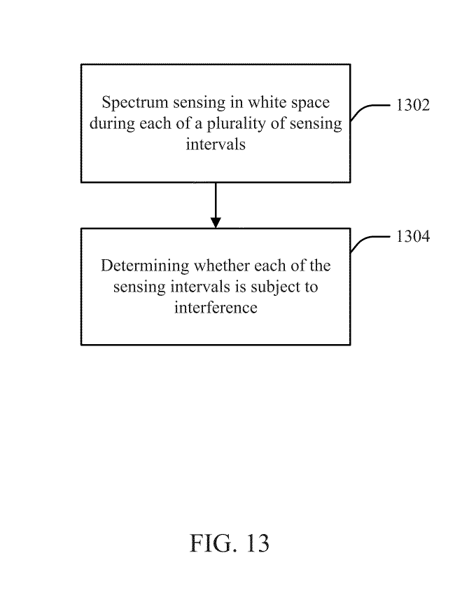

FIG. 13 illustrates a method of wireless communication in white space according to an embodiment of the disclosure. At block 1302, the method includes spectrum sensing in the white space during each of multiple of sensing intervals. At block 1304, the method includes determining whether each of the sensing intervals is subject to interference. The determining can be based on a time domain analysis of signal power during each sensing interval or based on a frequency domain analysis of signal power during each sensing interval.

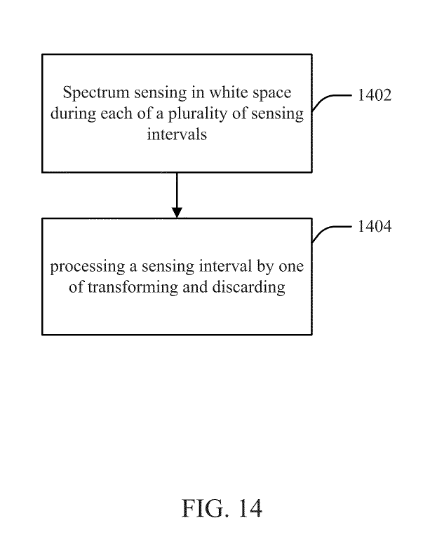

FIG. 14 illustrates an exemplary method of wireless communication in white space according to an embodiment of the disclosure. At block 1402, the method includes spectrum sensing in the white space during each of multiple of sensing intervals. At block 1404, the method includes processing a sensing interval by one of transforming and discarding the sensing interval based on an overload bit of an analog to digital converter. The transforming includes setting the power of an affected portion of the interfered signal to a predetermined value or a value interpolated from adjacent samples of the signal when the overload bit indicates occurrence of an overload condition. The discarding occurs when a number of overload bits of the analog to digital converter exceeds a predetermined threshold.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine or computer readable medium tangibly embodying instructions may be used in implementing the methodologies described herein. For example, software code may be stored in a memory and executed by a processor. When executed by the processor, the executing software code generates the operational environment that implements the various methodologies and functionalities of the different aspects of the teachings presented herein. Memory may be implemented within the processor or external to the processor. As used herein, the term “memory” refers to any type of long term, short term, volatile, nonvolatile, or other memory and is not to be limited to any particular type of memory or number of memories, or type of media upon which memory is stored.

The machine or computer readable medium that stores the software code defining the methodologies and functions described herein includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. As used herein, disk and/or disc includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present teachings and their advantages have been described in detail, it should be understood that various changes, substitutions and alterations can be made herein without departing from the technology of the teachings as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding aspects described herein may be utilized according to the present teachings. Accordingly, the appended claims are intended to include within their scope such processes, machines, manufacture, compositions of matter, means, methods, or steps.

What is claimed is:

1. A method of wireless communication in white space, comprising:
spectrum sensing in the white space during each of a plurality of sensing intervals; and
determining whether each of the sensing intervals is subject to interference based on a time domain analysis of signal power during each sensing interval.

2. The method of claim 1, in which the time domain analysis comprises determining whether a current signal power exceeds a previous signal power by a predetermined threshold.

3. The method of claim 1, in which the time domain analysis comprises determining whether a maximum signal power in a sensing interval exceeds at least one of a mean signal power and median signal power of the sensing interval by a predetermined threshold.

4. The method of claim 1, in which the time domain analysis comprises tracking whether a number of high power signal groups exceed a predetermined threshold.

5. The method of claim 1, further comprising determining whether each of the sensing intervals is subject to interference based on a frequency domain analysis of signal power during each sensing interval.

6. The method of claim 1, further comprising determining whether each of the sensing intervals is subject to interference based on a difference between a frequency domain analysis and a time domain analysis of signal power during each sensing interval.

7. The method of claim 1, further comprising discarding sensing results from each sensing interval determined to have been affected by interference.

8. The method of claim 1, further comprising transforming a portion of the sensed spectrum of each sensing interval determined to have been affected by the interference.

9. The method of claim 8, in which the transforming comprises one of setting the power of an affected portion of an interfered signal to a predetermined value and setting the power of an affected portion of the interfered signal to a value interpolated from adjacent samples of the signal.

10. A method of wireless communication in white space, comprising:
spectrum sensing in the white space during each of a plurality of sensing intervals; and
processing a sensing interval by one of transforming and discarding the sensing interval based on an overload bit of an analog to digital converter, the transforming comprising setting the power of an affected portion of an interfered signal to one of a predetermined value and a value interpolated from adjacent samples of the signal when the overload bit indicates occurrence of an overload condition, the discarding occurring when a number of overload bits of the analog to digital converter exceeds a predetermined threshold.

11. An apparatus for wireless communication in white space, comprising:
means for spectrum sensing in the white space during each of a plurality of sensing intervals; and
means for determining whether each of the sensing intervals is subject to interference based on a time domain analysis of signal power during each sensing interval.

12. The apparatus of claim 11, further comprising means for determining whether each of the sensing intervals is subject to interference based on a frequency domain analysis of signal power during each sensing interval.

13. The apparatus of claim 11, further comprising means for determining whether each of the sensing intervals is subject to interference based on a difference between a frequency domain analysis and a time domain analysis of signal power during each sensing interval.

14. The apparatus of claim 11, further comprising means for discarding sensing results from each sensing interval determined to have been affected by interference.

15. The apparatus of claim 11, further comprising means for transforming a portion of the sensed spectrum of each sensing interval determined to have been affected by the interference.

16. An apparatus for wireless communication in white space, comprising:
means for spectrum sensing in the white space during each of a plurality of sensing intervals; and
means for processing a sensing interval by one of means for transforming and means for discarding the sensing interval based on an overload bit of an analog to digital converter, the means for transforming comprising means for setting the power of an affected portion of an interfered signal to one of a predetermined value and a value interpolated from adjacent samples of the signal when the overload bit indicates occurrence of an overload condition, the means for discarding implemented when a number of overload bits of the analog to digital converter exceeds a predetermined threshold.

17. A computer program product for wireless communication in white space, comprising:
a computer-readable medium having a program code recorded thereon, the program code comprising:
program code to spectrum sense in the white space during each of a plurality of sensing intervals; and
program code to determine whether each of the sensing intervals is subject to interference based on a time domain analysis of signal power during each sensing interval.

18. The computer program product of claim 17, further comprising program code to determine whether each of the sensing intervals is subject to interference based on a frequency domain analysis of signal power during each sensing interval.

19. The computer program product of claim 17, further comprising program code to determine whether each of the sensing intervals is subject to interference based on a difference between a frequency domain analysis and a time domain analysis of signal power during each sensing interval.

20. The computer program product of claim 17, further comprising program code to discard sensing results from each sensing interval determined to have been affected by interference.

21. The computer program product of claim 17, further comprising program code to transform a portion of the sensed spectrum of each sensing interval determined to have been affected by the interference.

22. A computer program product for wireless communication in white space, comprising:
a computer-readable medium having a program code recorded thereon, the program code comprising:
program code to spectrum sense in the white space during each of a plurality of sensing intervals; and
program code to process a sensing interval by one of transforming and discarding the sensing interval based on an overload bit of an analog to digital converter, the transforming comprising setting the power of an affected portion of an interfered signal to one of a predetermined value and a value interpolated from adjacent samples of the signal when the overload bit indicates occurrence of an overload condition, the discarding occurring when a number of overload bits of the analog to digital converter exceeds a predetermined threshold.

23. An apparatus for wireless communication in white space, comprising:
a memory; and
at least one processor coupled to the memory, the at least one processor being configured:
to spectrum sense in the white space during each of a plurality of sensing intervals; and
to determine whether each of the sensing intervals is subject to interference based on a time domain analysis of signal power during each sensing interval.

24. The apparatus of claim 23, in which the processor is further configured to determine whether each of the sensing intervals is subject to interference based on a frequency domain analysis of signal power during each sensing interval.

25. An apparatus for wireless communication in white space, comprising:
a memory; and
at least one processor coupled to the memory, the at least one processor being configured:
to spectrum sense in the white space during each of a plurality of sensing intervals; and
to process a sensing interval by one of transforming and discarding the sensing interval based on an overload bit of an analog to digital converter, the transforming comprising setting the power of an affected portion of an interfered signal to one of a predetermined value and a value interpolated from adjacent samples of the signal when the overload bit indicates occurrence of an overload condition, the discarding occurring when a number of overload bits of the analog to digital converter exceeds a predetermined threshold.
